(19) United States
(12) Patent Application Publication
(10) Pub. No.: US 2026/0366697 A1
(43) Pub. Date: Nov. 19, 2026

(54) TRANSPARENT MULTI-LAYER SYSTEM

(71) Applicant: BASF COATINGS GMBH, Muenster (DE)

(72) Inventors: Markus MUNDUS, Muenster (DE); Sven Olle KRABBENBORG, Muenster (DE); Martin FRIEDRICH, Muenster (DE)

(21) Appl. No.: 19/135,258

(22) PCT Filed: Dec. 5, 2023
(86) PCT No.: PCT/EP23/84307

§ 371 Date: Jun. 3, 2025

(30) Foreign Application Priority Data
Dec. 21, 2022 (EP) 22215610.1

(51) Int. Cl. F21V 3/06; B32B 3/30; G02B 1/11

(52) U.S. Cl. CPC F21V 3/0625; B32B 3/30; B32B 2255/20; B32B 2307/40; B32B 2307/412; B32B 2307/7375; G02B 1/11

(57) ABSTRACT

Disclosed herein is a transparent multi-layer system, including a layer L₁ being composed of a transparent material having least one surface possessing microstructures which provide layer L₁ with glare control properties; and a layer L₂ being composed of one or more transparent materials providing layer L₂ with anti-reflective properties, where layer L₂ is on top of the surface of layer L₁ possessing the microstructures. Also disclosed herein are a method of producing such a multi-layer system, its use as glare control structure and a luminaire including a light emitting device, and such a multi-layer system.

The present invention relates to a transparent multi-layer system with improved glare control comprising a layer L₁ comprising microstructures and a layer L₂ formed on top of layer L₁ and a method on how to produce such transparent multi-layer system. The present invention further relates to the use of the transparent multi-layer system for optical components and light emitting devices such as luminaires and luminaires comprising such transparent multi-layer system.

### TECHNOLOGICAL BACKGROUND

Luminaires are omnipresent in everyday life in order to provide sufficient light regardless of the time of day. This applies to both indoor and outdoor luminaires as luminaires are used at home or in the office but also outside, for example at the tram station. Classical quality features of illumination are a sufficient level of illumination, a harmonic distribution of the brightness, prevention of reflection and mirroring, a correct color of light and a suitable color reproduction. Reflections of light rays occur when light passes from one medium, such as air, into a second medium such as glass or plastic. The degree of reflection can be calculated using the Fresnel equation. Thereby, it can be determined that the reflection of yellow-green light with a wavelength of 550 nm on glass without any anti-reflection coating is approximately 4%.

When light is emitted by a luminaire, some light rays leave the luminaire in glaring propagation angles, which represent large angles relative to the perpendicular of the luminous surface, causing discomfort to the occupants in the illuminated space or even violation of lighting regulations (for example in offices).

Glare control structures can be applied to suppress glaring beams from leaving luminaires and increase the total glare-free luminous flux. Such products are, e. g., transparent films or rigid panels comprising microstructures on the surface, wherein the smooth surface is affixed to the luminaire. The light rays incident on said microstructures are refracted in a way that the rays propagation angle is bend towards the direction normal to the substrate surface of said structure. Thereby, the luminous intensity distribution curve of a luminaire is narrowed to lower angles and glaring is controlled. Glare controlling structures are known for example from CH 711561 A1 and CH 711562 A1, which disclose optical foils containing microstructures with a plurality of elevations. Such structures are widely used since they reduce glaring beams and therefore provide a more pleasant light for the people within the illuminated area. However, the inventors of the present invention observed that the state-of-the-art structures are not sufficient to effectively control glaring beams because glaring beams are still observed and cause discomfort or even violation of lighting regulations (e.g., in offices). In the past, improvements were achieved by modifying the shape of the structures, for instance by changing the geometry or the angles of the respective microstructures.

However, even though structures as described in CH 711561 A1 and CH 711562 A1 are applied on top of light emitting devices such as luminaires resulting in some degree of glare control, there is a need to better control glaring beams, so that luminaires can be provided with a higher glare-free luminous flux and thus a high usable luminous flux and that occupants in the illuminated space are not disturbed by glaring beams. The Unified Glare Rating (UGR) is used for the assessment of discomfort glare. When determining the UGR value, all lights in the system are taken into account that contribute to the glare impression. The UGR limit values are specific for the respective activities that are carried out in the illuminated room, for example technical drawing, reading or general work in the industry. It is of outstanding importance to control glaring beams and to comply with the UGR limit values as glaring beams result in decreased concentration and fatigue of the glared person.

It was the aim of the present invention to improve the control of glaring of known glare control structures and to provide a higher glare-free luminous flux. Therefore, it was aimed to better control light rays exiting a state-of-the-art structure with glaring propagation angles. Thereby, the glare can be reduced and the usable luminous flux can be increased. Particularly, occupants in the illuminated space should not be disturbed by glaring beams.

### SUMMARY

The main object has been solved by the subject-matter of the present application as well as by the preferred embodiments thereof disclosed in this specification.

A first subject-matter of the present invention is a transparent multi-layer system, comprising
a) a layer L₁ being composed of a transparent material having least one surface possessing microstructures which provide layer L₁ with glare control properties, and
b) a layer L₂ being composed of one or more transparent materials providing layer L₂ with anti-reflective properties, wherein layer L₂ is on top of the surface of layer L₁ possessing the microstructures.

The afore-mentioned transparent multi-layer system being referred herein as “transparent multi-layer system according to the invention” or “multi-layer system according to the invention.”

The present invention further provides as a second subject-matter a method to produce a transparent multi-layer system according to the present invention comprising the steps of
i. forming a layer L₁, comprising microstructures on at least one surface, preferably on one surface, followed by
ii. forming an anti-reflective layer L₂ by
   a. depositing one or more coating materials on top of the surface of layer L₁ possessing the microstructures, thus forming an anti-reflective coating layer L₂., or
   b. partially removing material from the surface of layer L₁ possessing the microstructures thereby maintaining the shape of the microstructures and thus forming an antireflective layer L₂ being from the same material as layer L₁.

Another subject-matter of the invention is a transparent multi-layer system, which is obtainable according to the method of the invention.

A fourth subject-matter of the present invention is the use of the transparent multi-layer system according to the present invention as a glare-controlling component of a light emitting device such as a luminaire. This component being intended to be between the light source and a person being exposed to the light which is transmitted through the component.

Yet another subject-matter of the present invention is a luminaire comprising a light source and a transparent multi-layer system according to the present invention.

### DETAILED DESCRIPTION

### Definitions

The term “transparent” denotes a transmittance of visual light through a clear medium such as the materials, the multi-layer system according to the present invention is composed of.

A “clear medium” is a medium which allows the transmittance of visual light essentially without significant scattering. This contrasts with opaque media, which do not allow the transmittance of light on media such as milk glass, also called translucent glass, which allows a transmittance of visual light, but which is not a clear, but “milky” medium. In the context of the present invention, preferably, a degree of light transmittance through each layer material of the multi-layer systems of more than 80% should be observed. The degree of light transmittance is determined using ASTM D-1003 (Standard Test Method for Haze and Luminous Transmittance of Transparent Plastics).

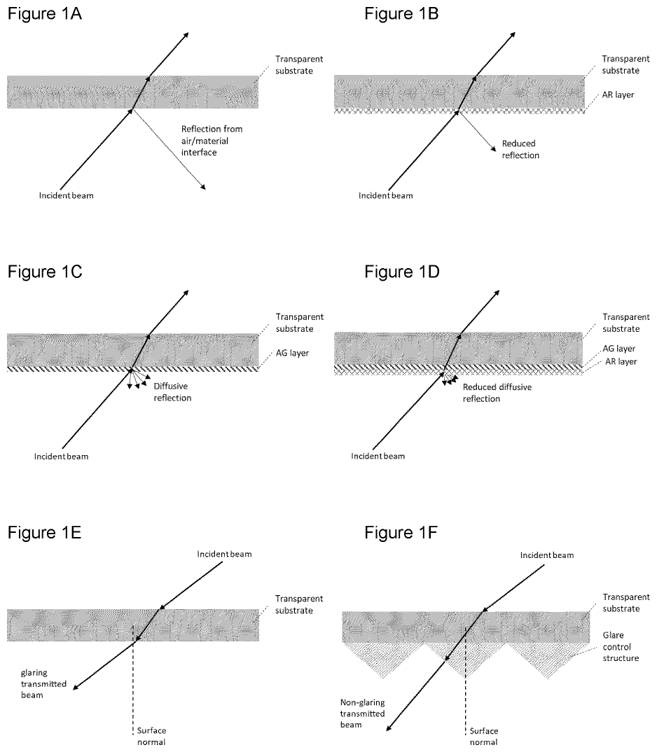

The term “anti-reflection” (also commonly abbreviated as AR) refers to a type of coating or treatment applied to optical surfaces, such as lenses or screens, to reduce or eliminate the reflection of light at the interface between the surface and the surrounding medium. Antireflection coatings work by utilizing the principle of interference in multiple layers of thin films with different refractive indices that are applied to the surface or by forming a gradient of refractive index between the medium and the surface. This gradient helps to reduce the abrupt change in refractive index, minimizing the reflection of light perceived by an observer compared to regular transparent substrates (FIG. 1B). By reducing reflections, anti-reflection coatings enhance the clarity, contrast, and brightness of the transmitted or reflected light. They are commonly used in various optical applications, including eyeglasses, camera lenses, microscopes, telescopes, solar panels, and display screens. Different materials, such as magnesium fluoride or titanium dioxide, can be used to create anti-reflection coatings, and the number and thickness of the layers can be optimized for specific wavelengths or ranges of light.

The term “anti-glare” (also commonly abbreviated as AG) refers to a type of optical layer or interface, such as screens or lenses, to reduce or eliminate the reflection or glare caused by ambient light or direct light sources. Anti-glare coatings work by diffusing or scattering the light of an external light source that hits the surface, rather than reflecting it back to the viewer (FIG. 1C). This results in a clearer and more comfortable image, with less eyestrain and visual fatigue. Anti-glare coatings are commonly used on computer monitors, smartphones, televisions, eyeglasses, camera lenses, and other optical devices. The anti-glare layer can be a microstructure with many different inclination angles to the surface, e.g., a randomized structure or a layer containing scattering centers, or can be made from a variety of materials, such as silica, titanium dioxide, or polyurethane, which can be applied using various methods, such as vacuum deposition, spray coating, or lamination.

The term “glare control” as used herein, on the other hand, refers to the ability of an optical layer or interface to reduce or eliminate the harsh, uncomfortable, and potentially hazardous effects of excessive brightness or glare from light sources, such as artificial lighting, transmitted through such surface. That is, compared to “anti-glare”, the observer is faced with beams passing through the optical layer or interface rather than being diffusively reflected from the optical layer or interface. In glare control, observer and light source are on opposite sides of such optical layer or interface. Glare control works by modifying the ray paths of light passing through an optical layer or interface such that the light beam incident on one side of the optical layer or interface leaves—after passing through—the other side at lower angles (respective to the substrate's surface normal) than the beam incident on the optical layer or interface (FIG. 1F).

FIGS. 1A to 1H further elucidate on the differences between anti-reflection (AR), anti-glare (AG), and glare-control (GC) as used herein, as well as the combination of the in literature known combination of an anti-reflection (AR) layer with an anti-glare (AG) layer as well as the here inventively disclosed combination of an anti-reflection (AR) layer with glare-control (GC) layer to surprisingly further reduce or eliminate glare as result of beams transmitted through glare-control (GC) structures.

FIG. 1A gives a schematic representation of a beam incident on a plane parallel transparent substrate. The incident beam is partially specular reflected and partially transmitted. The partial reflection on the second interface between material and air is omitted for clarity of graphical representation. FIG. 1B gives a schematic representation of a beam of light incident on a plane parallel transparent substrate with an antireflection layer present on the side of the substrate facing towards the light source. The incident beam is partially specular reflected and partially transmitted. Reflection reaching an observer is thereby strongly reduced to ideally close to zero percent.

FIG. 1C gives a schematic representation of a beam incident on a plane parallel transparent substrate with an antiglare structure present on the side of the substrate facing towards the light source. The incident beam is partially reflected and partially transmitted, whereby the amount of reflection is similar to a transparent substrate (FIG. 1A). The reflection is thereby diffusive and not specular. That is, the bundle of ray's incident on the surface from one direction is reflected to multiple directions. To that end, the anti-glare layer can be a microstructure with many different inclination angles to the surface, e.g., a randomized structure or a layer containing scattering centers.

FIG. 1D gives a schematic representation of a beam incident on a plane parallel transparent substrate with an antiglare structure and an antireflection layer present on the side of the substrate facing towards the light source. The incident beam is partially reflected and partially transmitted, whereby the antireflection layer strongly reduces the amount of reflection and the anti-glare layer spreads this strongly reduced amount of reflection diffusively. Thus, the combination of antireflection and anti-glare layer result in an even stronger suppression of glare from reflected rays on the same side of the substrate as the light source. Exemplary patent application concerning “anti-glare” and antireflection can be found for example in JP2022015702 A1 and US2015/0226882 A1.

FIG. 1E gives a schematic representation of a beam incident on and transmitted through a plane parallel transparent substrate. The incident beam and transmitted beam have the same propagation direction. Therefore, beams at a high angle of incidence relative to the surface normal continue propagating at such high angles after leaving the substrate. In luminaires for example, such rays at high angles increase the glare perceived by an observer.

FIG. 1F gives a schematic representation of a beam incident on and transmitted through a transparent substrate with glare control features present on the surface facing away from the light source. The incident beam and transmitted beam do not have the same propagation direction, as the angle of the transmitted beam is changed by the glare control structure. The transmitted beam will propagate at lower angles to the substrate's surface normal than the incident beam. Thereby, the glare perceived by an observer is reduced. Exemplary patent application concerning “glare control” can be found for example in CH 711561 A1 and CH 711562 A1.

FIG. 1G corresponds to the setup of FIG. 1F, with in addition shown a partial reflection of the incident beam at the interface of the glare control structure and air, with this partially reflected beam exiting the glare control structure after intermediate reflection at the incident side of the substrate at higher and therefore in terms of glare more harmful angles to the surface normal.

FIG. 1H gives a schematic representation of the present invention, wherein a beam is incident on and transmitted through a transparent substrate with glare control features and an antireflective layer (AR) present on the surface facing away from the light source. The antireflective layer strongly reduces—ideally to zero percent—the partial reflections at the interface of the glare control structure and air, thereby reducing the amount of glare after intermediate internal reflection.

### Transparent Multi-Layer System

The transparent multi-layer system of the present invention comprises or consist of a layer L₁ being composed of a transparent material having at least one surface possessing microstructures which provide layer L₁ with glare control properties, and an anti-reflective layer L₂ being composed of one or more transparent materials providing layer L₂ with anti-reflective properties, wherein layer L₂ is on top of the surface of layer L₁.

Hereinafter layer L₁ is also referred to as “glare control layer L₁” or just as “glare control layer”, while layer L₂ is also referred to as “anti-reflective layer L₂” or just as “anti-reflective layer”.

In the context of the present invention the anti-reflective layer L₂ improves the glare control properties of layer L₁ and thus the transparent multi-layer system of the present invention provides improved glare control properties.

It was the inventors of the present invention who found that the combination of a first layer possessing glare control properties with a second layer possessing anti-reflective properties leads to an improved glare control.

Both types of layers L₁ and L₂ are already found in the state of the art and are described in the prior art. However, the combination of both types of layers to improve glare control was not yet envisaged. In the following, both layers and methods of their production are described in more detail.

### Layer L₁

Layer L₁ provides at least one surface, preferably one surface, which possesses microstructures which employ a certain degree of glare control properties to said layer L₁, as, e.g., described in CH 711561 A1 or CH 711562 A1.

### Microstructure Shapes, Sizes and Patterns of Microstructures

Like every layer, layer L₁ has two surfaces, wherein at least one of the two surfaces, preferably one surface, has microstructures. The microstructures typically form a pattern, preferably a regular pattern, which is responsible for the glare control properties of said layer L₁. Preferably one surface of layer L₁ has microstructures and the other surface is a smooth surface (i.e., a flat surface without microstructures). In the below described use according to the invention, the smooth side is typically the side which shows to the light source.

The microstructures preferably have a height in the range of 5 μm to 5000 μm, more preferred 5 μm to 1000 μm, even more preferred 5 μm to 500 μm or 5 to 300 μm, even more preferred 5 to 150 μm, such as 30 to 120 μm or 30 to 100 μm. The “height of a microstructure” being the height of the elevations starting from the lowest point between the elevations. However, the height can vary significantly, while still glare control properties are observed. Within the same layer L₁ it is however preferred that the height of each microstructure is approximately the same to achieve a homogeneous impression.

The microstructures can have various shapes. They for example have the shape of cones, pyramids, or prisms. Microstructures having the shape of a pyramid can have a triangular or square base, wherein the pyramid can also be an inverse pyramid having a triangular or square base. Other possible microstructures are prisms, Fresnel lens-like structures, micro-lens-like structures having a hexagonal or square grid layout, or the combination of two linear structures of prisms.

Preferably the microstructures have a hexagonal, a square or other grid layout, most preferably a hexagonal grid layout.

Preferably the microstructures have the shape of cones, more preferably cones having a hexagonal grid layout. Preferably the cones have an apex angle of 90° to 130°, more preferably 100° to 120°, even more preferably 105° to 115°, most preferably 110°.

Preferably the microstructures have a base with a maximum diameter of 5 μm to 1000 μm, more preferably 50 μm to 500 μm, most preferably 150 μm to 350 μm. Preferably the microstructures have base angles in the range of 10° to 60°, more preferably 20° to 55°, wherein the base angle is the angle of inclination of the microstructure.

### Materials Used for Forming Layer L₁

The material forming layer L₁ preferably has a refraction index n₁, which is in the range from 1.35 to 2.00, more preferably 1.40 to 1.85, most preferably 1.45 to 1.75 determined at a wavelength of 589 nm. The term “refractive index” as used in this invention describes the ratio of the speed of light in vacuum to that in a given medium, at a wavelength of light of 589 nm.

Preferably layer L₁ is formed from glass or a polymeric material or blends of polymeric materials or blends of polymeric and inorganic material. The term “polymeric” describes substances, which are composed of multiple monomeric entities, which differ in terms of degree of polymerization, molar mass and chain length. The monomeric entities can be the same or different. The polymeric material is made of or contains polymeric substances as main ingredient. Thus, this term also includes cured coating materials, preferably obtained from liquid coating compositions, which are cured before layer L₂ is applied.

Optical glass has a range of refraction indices at a wavelength of 589 nm from approx. 1.46 (quartz glass) to 1.85 (for lanthanum heavy flint glass).

The polymeric material may be thermoplastic or thermoset and is preferably a thermoset material. It can be in form of a plastic foil, a plastic sheet or a cured coating obtained from a curable coating composition C₁.

Typical polymeric material such as plastic foils and plastic sheet, preferably consist of or comprise polyolefins such as polyethylene or polypropylene, polyvinyl chloride, celluloids, polystyrene, polyether ether ketone, polyamide, acrylonitrile butadiene styrene, polylactide (PL), polymethyl methacrylate (PMMA), polycarbonate, polyethylene terephthalate (PET), epoxy, polyurethane, polyurethane-acrylate, polyurea, poly(ethylene-propylene), polydiorganosiloxanes, polybutadiene, polychloroprene, chlorinated polyethylene and fluorosilicones, fluorinated polyurethanes, perfluoropolyethers, and/or blends thereof. The most preferred plastic materials are polycarbonate, PMMA and PET amongst which polycarbonate is most preferred.

Preferably layer L₁ comprising microstructures is a plastic foil or sheet known for example from CH 711561 A1 or CH 711562 A1. A plastic foil according to the present invention relates to a relatively large-area, thin structure. The structures typically have a much larger area in relation to their thickness. For example, such structures can have a thickness of less than 1 mm, typically less than 0.5 mm, while the surface can be of any size. Plastic sheets are considered being thicker in size such as 1 mm and more, but can be made of the same material as plastic foils.

The plastic foil or plastic sheet has a refraction index n₁ being preferably from 1.35 to 1.65, more preferably 1.40 to 1.60 determined using a wavelength of 589 nm. Preferably plastic foils and sheets are made from polycarbonate (n₁=1.59), polyethylene (n₁=1.50), polymethyl methacrylate (n₁=1.49), most preferably polycarbonate.

Besides the afore-mentioned typical materials such as glass or the polymeric materials, it is possible to form layer L₁ by coating technology. Thus, cured coatings, obtained from curable coating compositions C₁ can also be used to produce a thermoset polymeric material.

Amongst the curable coating compositions C₁, UV curable coating compositions are preferred. The term “UV curable coating composition” according to the present invention is to be understood as referring to a coating composition that can be partially or completely cured under the effect of ultraviolet radiation. Such UV curable coating compositions preferably comprise UV curable resins, UV curable reactive monomers (i.e., UV curable reactive diluents), photoinitiators, light stabilizers, and/or further coating additives.

Preferred UV curable resins are, e.g., selected from the group consisting of polyester (meth)acrylates; epoxy (meth)acrylates; aliphatic and/or aromatic urethane (meth)acrylates, preferably aliphatic urethane (meth)acrylates; polyether (meth)acrylates; and (meth)acrylated poly(meth)acrylates. The term “(meth)acrylic” or “(meth)acrylate” encompasses acrylic and methacrylic or both, as well as acrylate and methacrylate or both, respectively.

Suitable UV curable reactive diluents comprise preferably one or more free radically polymerizable groups, such as vinyl, allyl or (meth)acrylic groups, more preferably (meth)acrylic groups. Examples of suitable reactive diluents are mono(meth)acrylate functional monomers, di(meth)acrylate functional monomers and tri- and/or tetra(meth)acrylate functional monomers. Preferred mono(meth)acrylate functional monomers are hydrocarbylesters of (meth)acrylic acid, wherein the hydrocarbyl residues can be aliphatic or aromatic, and linear, branched, or cyclic, preferably the hydrocarbyl groups containing 1 to 20, more preferably 4 to 18 carbon atoms, wherein the hydrocarbyl group may contain one or more ether oxygens. Preferred di(meth)acrylate functional monomers are alkanediol di(meth)acrylates, wherein the alkanediol preferably contains 2 to 16, more preferred 3 to 14 carbon atoms; dialkyleneglycol di(meth)acrylates; trialkyleneglycol di(meth)acrylates; and neopentylglycol-propoxy di(meth)acrylate; tri(meth)acrylate functional monomers of trimethylolpropane, trimethylolethane or glycerol, and tetra(meth)acrylate-functional monomer such as pentaerythritol tetra(meth)acrylate.

The combined amount of UV curable resins and UV curable reactive diluents preferably ranges from 80 wt.-% to 99 wt.-%, more preferred from 85 to 98 wt.-%, and most preferred 90 to 97 wt.-% based on the total weight of the coating composition C₁.

Photoinitiators are used to start the cross-linking between any vinyl, acrylate and methacrylate groups within the coating composition. Photoinitiators enable the curing using UV light since photoinitiators create free radicals upon irradiation with UV light. Such photoinitiators are preferably selected from the group consisting of alpha-cleaving photoinitiators, such as alpha-hydroxyketones (e.g., benzoin, acetophenones), alpha-alkoxyketones (e.g., benzoinethers, benzilketales), alpha-aminoketones and acyl phosphine oxides. The UV photoinitiator is preferably present in the coating composition C₁ in an amount from 0.5 wt.-% to 6 wt.-% most preferably from 0.75 wt.-% to 5 wt.-% and even more preferred from 1 wt.-% to 3 wt.-% based on the total weight of the coating composition C₁.

The coating compositions C₁ may further comprise UV absorbers preferably selected from the group consisting of 2-(2′-hydroxyphenyl)benzotriazoles, 2-hydroxybenzophenones, esters of substituted and unsubstituted benzoic acids, acrylates like ethyl alpha-cyano-beta,beta-diphenylacrylates, 2-(2-hydroxyphenyl)-1,3,5-triazines and oxamides. The amount of UV absorbers preferably ranges from 0 wt.-% to 8 wt.-%, more preferred from 0.4 to 4 wt.-%, and most preferred 0.6 to 3 wt.-% based on the total weight of the coating composition C₁.

The coating compositions C₁ of the invention may also contain light stabilizers such as hindered amine light stabilizers (HALS) including NOR-HALS. The NOR-HALS is a sub class of HALS also called aminoxyl radical hindered amine light stabilizers. While HALS act as a base and become neutralized by acid for example hydrochloric acid, NOR-HALS, are not a strong base and are not deactivated by hydrochloric acid. The amount of light stabilizers preferably ranges from 0 wt.-% to 8 wt.-%, more preferred from 0.4 to 4 wt.-% and most preferred from 0.6 to 3 wt.-% based on the total weight of coating composition C₁.

The coating composition C₁ may also contain typical coatings additives, such as adhesion promoters like (meth)acrylic trialkoxysilanes, (meth)acrylic dialkoxyalkylsilanes, glycidyl group containing trialkoxysilanes, glycidyl group containing dialkoxyalkylsilanes, and (meth)acrylated phosphoric acid esters; levelling agents; antioxidants and defoamers, all the afore-mentioned preferably, but not necessarily, being reactive in UV-curing. The amount of coating additives is preferably in the range from 0 to 7 wt.-%, more preferred 0 to 5 wt.-% and most preferred 0 to 3 wt.-% based on the total weight of the coating composition C₁.

While not excluded, it is less preferred that the coating composition C₁ comprises organic solvents that—in contrast to UV-curable reactive diluents—do not chemically react with any of the other compounds of the coating composition upon UV-curing, i.e. such chemically non-reactive organic solvents in the sense of the present invention are a single liquid or blend of liquids, volatile under specified conditions of use, added to a coating composition to reduce viscosity or influence other properties without causing any deleterious effects. Preferably however, the coating composition C₁ does not contain said chemically non-reactive organic solvents.

UV-cured layers L₁ formed from the UV curable coating composition C₁ as described above are obtainable from a wide range of UV-curable ingredients contained in the UV curable coating composition C₁, which realize a wide range of refractive indices n₁.

The inventors of the present invention have surprisingly found that glaring beams can be better controlled, if a new approach is used, wherein a glare control structure layer L₁ is coated with an anti-reflective layer L₂.

### Layer L₂

Anti-reflective coating layer L₂ is formed on top of layer L₁, wherein the microstructure comprising surface of L₁ is directed towards layer L₂. It is also possible that layer L₂ is formed by removing material from the surface of layer L₁, as alternatively claimed, and described herein below. In such case layer L₂ is typically from the same material as layer L₁.

Typically, the refractive index n₂ of layer L₂ is lower than the refractive index n₁ of layer L₁ and thus the materials used to form layer L₂ and/or the fabrication techniques used in the formation of layer L₂ are selected in that n₁>n₂. For example, if layer L₂ is a single homogenous layer the refractive index of the material used is typically selected to fulfill n₁>n₂. On the other hand, it is, e.g., possible to use porous or nanostructured surfaces, which, e.g., by “entrapment” of air may reduce the overall refractive index of such layer L₂.

Generally speaking, the dry layer thickness di of layer L₂ is typically in the submicron range, preferably below 700 nm, such as from 10 to 700 nm, preferably 50 to 650 nm, even more preferred in the range from 80 to 600 nm, depending on structure, surface and material of the anti-reflective layer L₂.

Thus, the dry layer thickness di of layer L₂ is typically much smaller than the heights of the microstructures of layer L₁. Consequently, it is guaranteed that the microstructure of layer L₁ is passed on layer L₂, i.e., the valleys between the microstructures of layer L₁ remain and are not “filed up” by layer L₂.

Actually, any known anti-reflective layer L₂ can be formed on top of the microstructured surface of layer L₁, as long as the layer is transparent and fulfills some requirements in view of layer L₁ which make such layer L₂ being anti-reflective. Thus, the term “anti-reflective” already includes information such as an appropriate layer thickness of layer L₂ or its refractive index n₂ in view of the refractive index of layer L₁ being n₁.

Consequently, all necessary information regarding the term “anti-reflective” in view of the properties of layer L₂ are already included in qualifying as anti-reflective.

Moreover, since the concept of the present invention is based on applying an anti-reflective layer L₂ onto a layer L₁ as defined above the proof of concept carried out on a specific anti-reflective layer L₂ can easily transferred to another anti-reflective layer L₂, which is a big advantage of the teachings disclosed herein. Unlike concepts were the glare control layer itself is modified by using different shapes of the microstructures with unforeseeable outcome, the present invention can easily be adopted to any kind of anti-reflective layer L₂, and is thus, universally applicable.

The anti-reflective layers L₂ can be of various types, which can roughly be subsumed under the group of anti-reflective coating structures and the group of anti-reflective coating surfaces, both groups not necessarily excluding each other. A detailed description of the afore-mentioned anti-reflective coating structures and anti-reflective coating surfaces as well as techniques on how to produce such anti-reflective layers is disclosed in the review article by N. Shanmugam, R. Pugazhendhi, R. Madurai Elavarasan, P. Kasiviswanathan and N. Das, “Anti-Reflective Coating Materials: A Holistic Review from PV Perspective”, Energies 2020, 13, 2631 et seq., which is incorporated herein by reference, and the teachings of which are briefly summarized hereinafter.

In the following, different suitable anti-reflective coating structures will be described.

i. Single-Layer Anti-Reflective Coatings (SLARC)

An SLARC is the simplest form of an anti-reflective coating. In this case the Fresnel reflection loss is reduced by applying a single layer film on the glare control layer L₁, thus producing an anti-reflective layer L₂. To achieve the anti-reflective properties of an SLARC, it is required that the refractive index n₂ of the material forming layer L₂ is lower than the refractive index n₁ of layer L₁. The optimum zero reflectance of the SLARC in a multilayer coating according to the invention is achieved when the coating thickness equals to the quarter of the wavelength of the incident light. To get close to this case, the refractive index n₂ of the material of the SLARC layer L₂ is selected to be approximately (n₁)^{-0.5}, wherein n₁ is the refractive index of the material forming layer L₁.

As an example, if layer L₁ is made from glass having a refractive index n₁ of 1.5, the material forming the SLARC layer should as an optimum have refractive index n₂ of 1.22 with quarter-wave thickness.

Typically, solid materials having such low refractive indices are hardly available. However, e.g., magnesium fluoride MgF₂ having a refractive index of 1.38 is a commonly used material to produce such coating. Taking the above equation into account the optimum refractive index of the material forming layer L₁ would be a high-index glass having a refractive index of about n=1.90 at a quarter-wavelength layer thickness of layer L₂. Besides MgF₂ other materials such as SiO₂ are commonly used to produce SLARC layers.

Suitable organic materials for forming layer L₂ are those having low refractive indices as low as n=1.30 and often belong to the group of fluoropolymers.

The layer thickness d_{L} selected depends as described above on the light source and particularly the color of light. In case white light is assumed one of skill in the art may consider that such light contains all wavelength from about 380 to about 700. Thus, for most white light emitting light sources, it is preferred that the layer thickness d_{L} is in the range from d_{L}=λ/4, wherein λ=380 to 700 nm. In such case the d_{L} to be chosen is from approx. 95 nm to approx. 175 nm. Since glare by light of wavelength close UV light (wavelength below 380 nm) should be particularly avoided, d_{L} is preferably chosen from the lower part of the range from 85 to 175 nm. Thus, it is particularly preferred that du is in the range from 85 to 140 nm, more preferred in the range from 90 to 120 nm and most preferred in the range from 95 to 110 nm. The afore-mentioned values for di are particularly suitable if MgF₂ is selected as layer material in SLARCs.

ii. Double-Layer Anti-Reflective Coatings (DLARC)

DLARC employ two layers—herein referred to as L_{2.1} and L_{2.2}—both together forming layer L₂, the layers having the same or different thicknesses. For equal film thicknesses the condition for an optimum zero reflection can be described by the following formula (n_{2.1}/n_{2.2})=(nₐᵢᵣ/n₁)^{0.5}, wherein nₐᵢᵣ=refractive index of air, n₁=refractive index of the material of layer L₁, and n_{2.1} and n_{2.2}=refractive indices of layers L_{2.1} and L_{2.2}, respectively, and layer L_{2.1} being the layer which is in direct contact with layer L₁. In general, when a typical DLARC is used, the effective reflectance decreases significantly and approaches zero at the target wavelength and then increases gradually, thus exhibiting a V-shaped reflectance curve in the analyzed spectral range.

iii. Multi-Layer Anti-Reflective Coatings (MLARC)

MLARC employ more than two layers forming the overall layer L₂. MLARC can typically avoid the gradual increase of the reflection as observed for DLARC. As an example, the reflectance for an MgF₂/ZnS DLARC is 9.1% and 0.58% at 500 nm and 1000 nm, whereas for an MgF₂/Al₂O₃/ZnS MLARC (triple-layer) it is 5.8% and 0.88% at 500 nm and 1000 nm, respectively. This shows the broader low reflectance in the multi-layer coating.

iv. Gradient Refractive Index Coatings (GRINC)

A sequence of layers having a refractive index changing gradually at each step constitutes gradient refractive index coating. Alternatively, an inhomogeneous film of monotonically varying refractive index is preferred, and also it serves as a broadband anti-reflective coating. Different profiles of GRINC have been proposed for omnidirectional and broadband anti-reflective coatings, which include linear, parabolic, cubic, gaussian, quintic, exponential, exponential-sine, and Klopfenstein. Linear index profiles can be achieved easily on silicon or quartz substrates. The refractive index gradients can be achieved by varying the packing density of the layer; however, this may affect the mechanical robustness and durability of the layer.

In the following different suitable anti-reflective coating surfaces will be described.

### V. Porous Layers

Porous layers, particularly nano-porous layers can also act as anti-reflection coating layer. For such kind of layers, it is essential that the size of the pores is much smaller than the wavelength of the incident light. The refractive index of such nano-porous materials is averaged over the layer L₂. Porous layers L₂ can for example be in form of SLARC and GRINC structures and being produced by chemical etching processes followed by a heat treatment. In another approach a high performance broadband anti-reflection coating was obtained by using nanophase-separated polymer films and precisely varying the volume fraction, as described by Walheim, S.; Walheim, S.; Schaffer, E.; Mlynek, J.; Steiner, U. under the title “Nanophase-Separated Polymer Films as High-Performance Antireflection Coatings” in Science 1999, 283, 520-522. With the latter technique it was possible to obtain refractive indices n₂ in the range of 1.2 to 1.05 and a high transmittance of 99.7% in the wavelength span of visible light.

vi. Biomimetic Photonic Nanostructures

This kind of layers L₂ is based on sub-wavelength structures (SWS). SWS in a periodic arrangement acting as an antireflective surface was first discovered in the night-flying moth's eye by Bernhard in 1967. The antireflective structure of the moth-eye consists of an outer surface having sub-micron height and spaced nipple arrays. Therefore, the index of refraction varies progressively between air and substrate, actively suppressing the reflection at the juncture of two media. The reflectance of such structure depends on the spacing between the arrays, the effective height of the nanostructures, and the wavelength. In an ideal case, antireflective properties for broad bandwidth can be obtained through regulating the space as fine as possible and by increasing the height. For replicating the nipple structures, three models were proposed having conical, paraboloidal, and Gaussian-bell shapes, and it has been reported that parabolic shaped nipple exhibited excellent antireflective performance at normal incidence. Also, a significant decrease of reflectance takes place for nipples having greater width where they overlap at the base and is progressively reduced when the height is increased. Mono-layers having a gradient refraction index and a moth-eye pattern are inter alia known from Han et al. in Biosurface and Biotribology 2 (2016) 137-150; or Choi et al. in Polymers (2020), 12, 296.

Such nanostructures may preferably possess a height of 10 nm to 500 nm, more preferably 20 nm to 400 nm, even more preferably 50 nm to 300 nm, even more preferably 100 nm to 300 nm, most preferably 300 nm. The diameter of the nanostructures preferably being 10 nm to 500 nm, more preferably 20 nm to 300 nm, most preferably 50 nm to 100 nm; and preferably.

vii. Textured Surfaces

Surfaces having a texturization period lesser than the target wavelength and height being a fraction of the wavelength are also suitable for anti-reflective applications. Theoretically, if the wavelength of the light is much larger than the spacing between the structures, then the textured surface can be treated as layers with gradually changing refractive index, and the optical properties can be predicted by utilization of effective medium approximation. If the wavelength of the light is shorter than the period between textured structures, the rays would undergo multiple reflections and get trapped inside the crevices. In this case, the optical properties are defined by geometry only, and the numerical modeling is carried out with the help of a ray-tracing method.

### Materials Used for Forming Layer L₂

Depending on type the anti-reflective coating structures and/or surfaces a plurality of different materials, which are deposited by different techniques can be applied. In the following different suitable types of materials and their application techniques are disclosed.

The anti-reflection coating materials are preferably classified into the following groups of materials:
a. Silicon-based coating materials, e.g., encompassing silicon oxide and silicon-based nanomaterials;
b. Metal-based coating materials, e.g., encompassing metal oxides and metal fluorides;
c. Polymer-based coating materials, such as, e.g., polystyrene, polymethylmethacrylate, polydimethylsiloxane and polyethylene terephthalate; and
d. Composite coating materials.
   a. Silicon-Based Anti-Reflection Coating Materials

Silicon-based coating material is often and preferably based in form of silicon dioxide (i.e., silica) coating materials.

Single silica layers can, e.g., be formed as nanoporous layers by sol-gel dip-coating as, e.g., described by Mahadik, D. B.; Lakshmi, R. V.; Barshilia, H. C., “High performance single layer nano-porous antireflection coatings on glass by sol-gel process for solar energy applications”, Sol. Energy Mater. Sol. Cells 2015, 140, 61-68; or by chemical etching and thermal oxidation as described by Cao, H.; Bai, Y.; Qiao, L., “Antireflection effect of SiO₂ thin film on the pyramidal textured surface of monocrystalline silicon”, Opt. Int. J. Light Electron Opt. 2015, 126, 2643-2645.

Double layer porous silica films possessing an extraordinarily low refractive index of about 1.11 may, e.g., be obtained by plasma-enhanced chemical vapor deposition techniques as, e.g., described by Nagel, H.; Metz, A.; Hezel, R., “Porous SiO2 films prepared by remote plasma-enhanced chemical vapour deposition—a novel antireflection coating technology for photovoltaic modules”, Sol. Energy Mater. Sol. Cells 2001, 65, 71-77.

Multi-layer stacks of silica, obtained by sol-gel evaporation induced self-assembly techniques are described by Agustin-Saenz, C.; Sanchez-Garcia, J. A.; Machado, M.; Brizuela, M.; Zubillaga, O.; Tercjak, A., “Broadband antireflective coating stack based on mesoporous silica by acid-catalyzed sol-gel method for concentrated photovoltaic application”, Sol. Energy Mater. Sol. Cells 2018, 186, 154-164.

A four-layer nanoporous silica structure obtained by glancing angle deposition technique showing a negligible reflection was obtained by Sobahan, K. M. A.; Park, Y. J.; Kim, J. J.; Hwangbo, C. K. and described in “Nanostructured porous SiO2 films for antireflection coatings”, Opt. Commun. 2011, 284, 873-876; and a five-layer structure with hollow silica nanoparticles obtained by dip-coating was disclosed by Jia, G.; Ji, Z.; Wang, H.; Chen, R., “Preparation and properties of five-layer graded-refractive-index antireflection coating nanostructured by solid and hollow silica particles”, Thin Solid Film 2017, 642, 174-181.

More sophisticated, but nevertheless cost-effective and easy to obtain structures as, e.g., nanocylinders can be formed by sol-gel and soft-imprint lithography as described by Van de Groep, J.; Spinelli, P.; Polman, A., “Single-Step Soft-Imprinted Large-Area Nanopatterned Antireflection Coating” Nano Lett. 2015, 15, 4223-4228.

Silica-based moth-eye like structures are also obtainable, e.g., by sol-gel dip coating and electrostatic self-assembly techniques as described by Li, D.; Han, S.; Li, A.; Wang, Y.; Shan, Y.; Huang, F., “Novel-type nanostructured SiO₂ antireflection coatings and their application in Cu(In,Ga)Se2 solar cells”, Mater. Chem. Phys. 2015, 165, 97-102

b. Metal-Based Anti-Reflection Coating Materials

Commonly used metal oxides in anti-reflective coating materials are titanium dioxide, indium-tin-oxide (ITO), aluminum oxide, tantalum oxide and zinc oxide, while the most important metal fluoride is magnesium difluoride.

The fabrication of titanium dioxide thin films can, e.g., be accomplished by liquid phase deposition as described by Huang, J.-J.; Lin, C.-C.; Wuu, D.-S., “Antireflection and passivation property of titanium oxide thin film on silicon nanowire by liquid phase deposition”, Surf. Coat. Technol. 2017, 320, 252-258.

Zinc oxide thin film are available by sol-gel methods as described by Makableh, Y. F.; Vasan, R.; Sarker, J. C.; Nusir, A. I.; Seal, S.; Manasreh, M. O., “Enhancement of GaAs solar cell performance by using a ZnO sol-gel anti-reflection coating. Sol. Energy Mater. Sol. Cells 2014, 123, 178-182.

Moth-eye structures from zinc oxide were described by Shin, B.-K.; Lee, T.-I.; Xiong, J.; Hwang, C.; Noh, G.; Cho, J.-H.; Myoung, J.-M., “Bottom-up grown ZnO nanorods for an antireflective moth-eye structure on CuInGaSe2 solar cells. Sol. Energy Mater. Sol. Cells 2011, 95, 2650-2654.

MgF₂ coatings may, e.g., form mesoporous nanoparticle layers by lyothermal and dip coating processes as described by Pendse, S.; Chandra Sekhar Reddy, K.; Narendra, C.; Murugan, K.; Sakthivel, S., “Dual-functional broadband antireflective and hydrophobic films for solar and optical applications”, Sol. Energy 2018, 163, 425-433.

c. Polymer-Based Anti-Reflection Coating Materials

With polystyrene (PS), using microinjection compression molding techniques, biomimetic nanopillars and pyramid array films can be produced as, e.g., described by Xie, H.; Huang, H.-X.; Peng, Y.-J. “Rapid fabrication of bio-inspired nanostructure with hydrophobicity and antireflectivity on polystyrene surface replicating from cicada wings”, Nanoscale 2017, 9, 11951-11958; and Peng, Y.-J.; Huang, H.-X.; Xie, H. “Rapid fabrication of antireflective pyramid structure on polystyrene film used as protective layer of solar cell”, Sol. Energy Mater. Sol. Cells 2017, 171, 98-105.

Polymethylmethacrylate (PMMA) coatings with nano-cone arrays can be produced as described by Choi, K.; Park, S. H.; Song, Y. M.; Lee, Y. T.; Hwangbo, C. K.; Yang, H.; Lee, H. S., “Nano-tailoring the Surface Structure for the Monolithic High-Performance Antireflection Polymer Film”, Adv. Mater. 2010, 22, 3713-3718; and simple, large scale nanopatterns can cost-effectively be produced using thermal nanoimprinting, laser lithography and dry etching as shown by Kim, S.; Jung, U. T.; Kim, S.-K.; Lee, J.-H.; Choi, H. S.; Kim, C.-S.; Jeong, M. Y, “Nanostructured Multifunctional Surface with Antireflective and Antimicrobial Characteristics”, ACS Appl. Mater. Interfaces 2015, 7, 326-331.

Other approaches make use of polydimethylsiloxanes (PDMS) or polyethylene terephthalate (PET) forming nano-domes, poly(methylsilsesquioxane) (PMSSQ) providing nano-porous films possessing a refractive index ranging from 1.44 to as low as 1.18; and others as described in Table 5 of the aforementioned publication from by N. Shanmugam, et al. in Energies 2020, 13, 2631 et seq.

d. Composite Coating Materials

Numerous approaches making use of combinations of two or more of SiO₂, TiO₂, Al₂O₃ ZnO, and MgF₂ are described in Table 6 of the aforementioned publication from by N. Shanmugam, et al. in Energies 2020, 13, 2631 et seq. as well as the underlying scientific publications showing on how to produce such coatings.

Additional Layers L_{S} and L_{A}

The inventive transparent multi-layer system may be on top of one or more additional layers, wherein the smooth surface of layer L₁ is directed towards the one or more additional layers. The one or more additional layers can be a support layer L_{S}, which is suitable to support the inventive transparent multi-layer system for example by providing a layer L_{S} on which the coating composition C₁ can be applied to form layer L₁.

Preferably layer Lₛ is formed from a coating composition comprising a polymer selected from the group consisting of polyolefins such as polyethylene or polypropylene, polyvinyl chloride, celluloids, polystyrene, polyether ether ketone, polyamide, acrylonitrile butadiene styrene, polylactide, polymethyl methacrylate, polycarbonate, polyethylene terephthalate, polyether ketone ketone, polyether ketone, polyimide, polyester, chloro- or fluoro-polymers such as polytetrafluoroethylene, fluorinated ethylene propylene or fluorinated polyurethane, silicones, epoxy, polysulfide, ethylene propylenediene, fluorosilicone and/or fluoroelastomers.

Furthermore, layer L₁ of the inventive transparent multi-layer system or layer L_{S} can be formed on additional layer L_{A} consisting of a material that enables the attachment of the inventive transparent multi-layer system on a transparent part of a luminaire to equip this part with an improved glare control structure. Suitable examples of additional layers L_{A} are for example layers consisting of or comprising an adhesive composition. Such adhesive layer might again be covered with a backing layer L_{B}, which is to be detached before fixing the transparent multi-layer system of the present invention, on the transparent part of the luminaire.

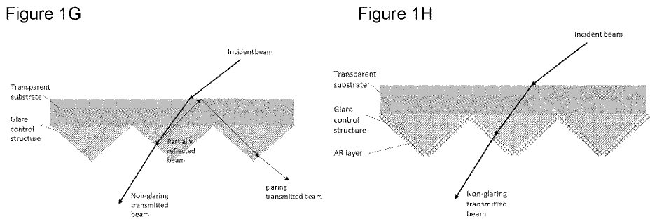

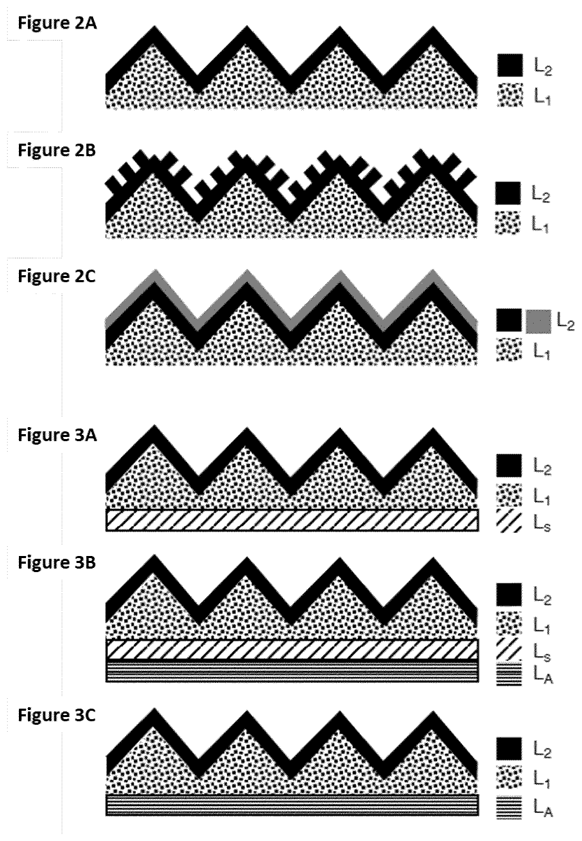

Thus, the transparent multi-layer system according to the present invention comprises layer L₁ and layer L₂, wherein layer L₂ is a mono-layer having a constant refraction index n₂ (cf. FIG. 2A) or a mono-layer having a gradient refraction index n_{2G} (cf. FIG. 2B) or a multi-layer film formed from multiple materials, wherein each layer has a different refraction index, wherein each refraction index is smaller than refraction index n₁ (cf. FIG. 2C). For simplification, multi-layer L₂ is shown in FIG. 2C as a two-layer structure consisting of a grey layer and a black layer. However, multi-layer L₂ can consist of more than two layers as outlined hereinbefore. The transparent multi-layer system according to present invention comprising additional layers L_{S} and/or L_{A} are indicated in FIGS. 3A to 3C, wherein layer L₂ is depicted as a mono-layer for simplicity as in FIG. 2A. Layer L₁ of the transparent multi-layer system according to present invention can be formed on top of support layer L_{S} (cf. FIG. 3A). Furthermore, the transparent multi-layer system according to the present invention comprising support layer L_{S} can be formed on top of additional layer L_{A} (cf. FIG. 3B). Moreover, the transparent multi-layer system according to the present invention can be formed on top of additional layer L_{A} without a support layer L_{S} in between layer L₁ and L_{A} (cf. FIG. 3C).

### Method to Produce the Transparent Multi-Layer System

As described above, the present invention further provides a method to produce a transparent multi-layer system according to the present invention comprising the steps of
i. forming a layer L₁, comprising microstructures on at least one surface, preferably on one surface, followed by
ii. forming an anti-reflective layer L₂ by
   a. depositing one or more coating materials on top of the surface of layer L₁ possessing the microstructures, thus forming an anti-reflective coating layer L₂., or
   b. partially removing material from the surface of layer L₁ possessing the microstructures thereby maintaining the shape of the microstructures and thus forming an antireflective layer L₂ being from the same material as layer L₁.

The materials of the different mandatory layers L₁ and L₂, as well as the optional layers Lₛ and Lₐ, including their physical properties, such as the refraction index, or their chemical compositions and also their dimensions, such as the layer thicknesses are already described herein above for the transparent multi-layer system of the present invention. Therefore, in this regard, it can be referred to the respective passage herein above.

The term “partially removing material” refers to ablation techniques like etching techniques, such as plasma etching, which are apt to create a substructure on layer L₁ by ablating part of the surface of this layer, thus creating an antireflective layer L₂. “Maintaining the shape of the microstructures” means that the general shape of the microstructures of layer L₁ remains, but the surface of such microstructures is sub-structured to obtain antireflective properties. Thus, such sub-structured surface is regarded as antireflective layer L₂ in the context of the present invention.

In the following it will be focused on how to obtain such transparent multi-layer system.

### Step i.

Above step i. requires forming a layer L₁ comprising microstructures on at least one of the two surfaces, wherein the microstructures have a height in the range of 5 μm to 100 μm, and said layer having a refraction index n₁.

The formation of such microstructures can be accomplished by several methods, such as laser ablation, hot stamping, ultraviolet casting, injection molding, compression molding, roll-to-roll processes, embossing processes, plasma etching processes, sol-gel-processes and/or 3D printing.

In the hot stamping process, pressure and heat a combined to form microstructures on a film or sheet. In this method, the film or sheet is brought into a stamping machine. The stamping machine comprises a stamping head having the desired microstructures in their inverted form. The heated stamping head is pressed onto the film or sheet to impress the desired microstructure to the film or sheet in order to obtain form layer L₁. The stamping temperature should be in the range of 100 °C to 250 °C. Since this method uses heat to impress the microstructure to the film or sheet, the material used need to be formable under heating. Thus, transparent multi-layer systems, wherein layer L₁ is formed from such material, may suitably be used only with light emitting source, which do not produce much heat, such as light emitting diodes. Otherwise, there is the risk of deformation of layer L₁ or a flattening of the microstructures over time could occur.

The microstructures can also be formed using an injection or compression process, both of which also make use of heat and/or pressure. In such process a mold having the desired microstructures is used for the injection molding process. The molten polymeric material is injected into such mold. Then, the mold is opened after a cooling process and the solid layer comprising the microstructures is ejected. For compression molding, the preferably thermoplastic material is placed into a hot mold having the desired microstructures. Subsequently, the mold is closed by a hydraulic press. The heat and pressure results in the formation of a layer L₁ having microstructures on at least one of the two surfaces.

Another method making use of pressure to produce the desired microstructures on layer L₁ is an embossing process, wherein an embossing tool with the inverted desired microstructures is used. The embossing tool is transferred on at least one of the two surfaces of layer L₁ formed from the uncured composition C₁ to form the microstructures on at least one surface of layer L₁.

Microstructures can be formed on layer L₁ using a plasma etching process. For example, Ar/O₂ SF₆, N₂ or CIF₃ can be used as a plasma for etching. Microstructures are formed on the surface of a polymeric film or sheet by etching the surface with a plasma in a vacuum chamber. The process is known for example as AR-plas® and AR-plas2®. Preferably layer L₁ is formed from films or sheets of polymethyl methacrylate or polycarbonate, if the microstructures are formed using a plasma etching process.

Roll-to-roll processing, can also be used to create structures on a roll of material or flexible glass. This processing is characterized in a process of applying coating, printing, or performing other processes starting with a roll of a flexible material and re-reeling after the process to create an output roll. These processes, and others such as sheeting, can be grouped together under the general term converting. When the rolls of material have been coated, laminated, or printed with the microstructure, they can be subsequently slit to their finished size on a slitter rewinder.

The microstructures can be formed using ultraviolet (UV) casting, wherein a UV curable coating composition is subjected to a casting mold, which is highly permeable to UV-light and exhibits the desired microstructures, wherein a UV curable coating composition is to be understood as referring to a coating composition that can be partially or completely cured under the effect of ultraviolet radiation. The hardening occurs in the mold by ultraviolet radiation, wherein ultraviolet radiation refers to radiation in a wavelength in the range of 100 nm to 380 nm, more preferably 280 nm to 380 nm, most preferably 315 nm to 380 nm.

Particularly preferred is roll-to-roll UV nanoimprint lithography.

### Step ii.

In the section above about the structures, surfaces, and materials of layer L₂ reference to numerous coating techniques is already made, which can be classified in conventional techniques and unconventional techniques.

The conventional techniques can again be grouped in “bottom-up” approaches and “top-down” approaches. Most important amongst the so-called bottom-up approaches are the sol-gel method, thermal evaporation, sputtering, glancing angle deposition (GLAD) and chemical vapor deposition (CVD), which are processes according to step ii. a., while for the so-called top-down approaches wet-etching and dry-etching are to be named, which are processes according to step ii. b.

The unconventional techniques are particularly lithography, such as photolithography, focused ion beam techniques and nanoimprint techniques; micro replication; photo aligning and photo patterning.

All the afore-mentioned techniques are known techniques and in principle suitable to deposit the anti-reflection coating material on top of the surface of layer L₁ to form anti-reflective layer L₂. They are described above and belong to the common knowledge of one skilled in the art. For experimental details it is referred to the review article by N. Shanmugam, R. Pugazhendhi, R. Madurai Elavarasan, P. Kasiviswanathan and N. Das, “Anti-Reflective Coating Materials: A Holistic Review from PV Perspective”, Energies 2020, 13, 2631 et seq. (Chapter 5) and the therein cross-referenced scientific articles providing more details on the fabrication techniques.

It is also clear for one of skill in the art that techniques destroying the integrity of layer L₁ are to be excluded. For example, techniques making use of heat may, e.g., be applied to form layers L₂ on glass layers L₁ but might not be suitable for thermoplastic layers L₁; or techniques making use of certain non-aqueous solvents in anti-reflection coating materials to form layers L₂ might be problematic if used on certain polymeric materials used for manufacture of layer L₁, which may swell of dissolve upon use of such solvents. Such undesired interactions are known to one of skill in the art and can be avoided by use of other material combinations for L₁ and L₂.

Further subject-matter of the invention is a transparent multi-layer system, which is obtainable according to the method of the invention.

### Use of a Transparent Multi-Layer System

The transparent multi-layer system according to the present invention is suitable for multiple applications, preferably as a glare-reducing component of a light emitting device such as a luminaire. The transparent multi-layer system according to the present invention can also be used for any other components through which light should transmit with a high transmittance but extremely low glare. Such further components are preferably selected from the group consisting of windows, imaging lens, and solar cells. The inventive transparent multi-layer system preferably intended to cover the light source of the luminaire in a direction of emission of the luminaire. Thus, multi-layer system is intended to be between the light source and a person being exposed to the light which is transmitted through the multi-layer system or component comprising the multi-layer system.

### Luminaire Comprising a Transparent Multi-Layer System

The present invention further provides a luminaire comprising a light source and a transparent multi-layer system according to the present application. The inventive transparent multi-layer system covers the light source of the luminaire in a direction of emission of the luminaire. Generally, the light source of the luminaire is separated from the multi-layer system according to the present invention by an air gap. Furthermore, the multi-layer system can be attached to a transparent part of the luminaire through the additional layer L_{A}, which is an adhesive, so that such transparent part, the additional layer L_{A} and the multi-layer system form a stack. Such transparent part could, e.g., be a rigid substrate, such as a polymethylmethacrylate plate. Such stack can be installed in manufacture of the luminaire or later, facing the light source, but still leaving an air gap between the light source and such transparent part. The luminaire can be an indoor or outdoor luminaire, preferably an indoor luminaire. Indoor luminaires can be ceiling luminaires, wall lights, floor luminaires, hanging luminaires or table luminaires.

### EXPERIMENTAL SECTION

### Methods

### Determination of the Thickness of the Individual Layers and the Multi-Layer System

The thickness of the individual layers and the multi-layer system was determined by scanning electron microscopy.

### Determination of Light Transmittance

The degree of light transmittance of layers L₁ and L₂ and the multilayer system of the invention can be determined using ASTM D-1003 (Standard Test Method for Haze and Luminous Transmittance of Transparent Plastics).

### Determination of the Usable Luminous Flux (Use φ)

The luminous flux describes the amount of light emitted by a light source. The usable luminous flux (use φ) describes the amount of luminous flux that is incident on a surface. The luminous flux was determined from photometric measurements using a goniophotometer for the measurement of the luminous intensity distribution.

### Determination of the Unified Glare Rating (UGR)

The UGR value can be calculated by the following formula (I)

$$U G R = 8 log ( {\underbrace{\frac{0 , 25}{{L}_{b}} \sum \frac{{L}^{2} Ω}{{P}^{2}}}}_{\begin{matrix}( 1 ) & ( 2 )\end{matrix}} ) , \qquad ( I )$$

wherein
L_{b} is the background luminance in cd/m² calculated as E_{ind}Π⁻¹, in which E_{ind} is the vertical indirect illuminance at the observer's eye,
L is the mean luminance in cd/m² of the light exit area of each lamp in the direction of the observer's eye,
Ω is the spherical angle in steradians (sr) of the light emitting surface of each luminaire, based on the observer's eye,
ρ is Guth's position index for each individual luminaire, depending on its spatial deviation from the main viewing direction.

The procedure is described in detail in CIE117:1995 or CIE190:2010, respectively. The UGR limit values for interior lighting are specified in EN 12464, while the UGR limit values for outdoor lighting are specified in EN 12464-2.

### Determination of the Refraction Index

The refraction index or refractive index was determined at a wavelength of 589 nm with a refractometer.

### Simulation of the Effect of the Inventive Transparent Multi-Layer System on Glaring Beams

To investigate the influence of the inventive transparent multi-layer system on glaring beams exiting a luminaire, a simulation was performed using the Fresnel equations. Three different conditions were simulated. First, the reflection of light rays was simulated for the state-of-the-art glare control structure as layer L₁ (“GCS”), known from patent CH 711562 A1. The light propagation through the glare control structure was simulated for different apex angles as indicated in Table 1. Furthermore, an idealized case was simulated, in which surfaces were assumed to be only transmitting but not reflecting incident light (“transmitting”). Then, the light propagation was simulated for a multi-layer system according to the present invention comprising a glare control structure as described above as layer L₁ and layer L₂ on top of L₁, wherein L₂ is formed of MgF₂ having a dry layer thickness of 100 μm (“MgF₂”). Thus, the condition “MgF₂” comprises the same glare control structure as in condition “GCS”. The conditions “GCS” and “MgF₂” differ in that the glare control structure in condition “GCS” is uncoated, while the glare control structure in condition “MgF₂” is coated with a MgF₂ layer having a dry layer thickness of 100 μm.

To determine the level of glare, the unified glare rating (UGR) was determined using CIE117 and CIE190. The lower the UGR value, the lower is the glare effect.

TABLE 1

| apex | UGR (CIE117) | | | UGR (CIE190) | | |
|---|---|---|---|---|---|---|
| angle | GCS | transmitting | MgF₂ | GCS | transmitting | MgF₂ |
| 100° | 17.20 | 17.00 | 17.00 | 16.42 | 16.07 | 16.08 |
| 110° | 16.90 | 16.50 | 16.60 | 15.70 | 14.99 | 15.20 |
| 120° | 18.10 | 17.90 | 17.90 | 17.27 | 16.97 | 16.98 |

The UGR values for all apex angles are lower in the idealized situation (“transmitting”) compared to the condition, in which an uncoated glare control structure is used (“GCS”). The UGR values in example “GCS” represent the level of glare using the state-of-the-art glare control structure. The level of glare is reduced by a transparent multi-layer system according to the present invention comprising the glare control structure of CH 711562 A1 as layer L₁ and MgF₂ as layer L₂ compared to the uncoated glare control structure. The lowest level of glare using a transparent multi-layer system according to the present invention is observed for the apex angle of 110° with 16.60 (CIE 117) or 15.20 (CIE190).

From the data above the maximum usable luminous flux in klm per luminous surface area in m² (use φ) was calculated for UGR=19 at room size 4H/8H (and room conditions 70% ceiling reflection, 50% wall reflection, 20% floor reflection). Additionally, the gain of the usable luminous flux due to the inventive transparent multi-layer system relative to the uncoated glare control structure was calculated for both CIE117 and CIE190. Moreover, the gain of the usable luminous flux in the idealized case relative to the uncoated glare control structure was calculated. The values of the gain of the usable luminous flux are indicated in brackets. The values of the usable luminous flux were simulated for the apex angles indicated in Table 2.

TABLE 2

| apex | useφ (klm/m², CIE117) | | | useφ (klm/m², CIE190) | | |
|---|---|---|---|---|---|---|
| angle | GCS | transmitting | MgF₂ | GCS | transmitting | MgF₂ |
| 100° | 22.31 | 24.10 | 23.77 | 27.93 | 31.49 | 30.98 |
| | | (+8.0%) | (+6.5%) | | (12.8%) | (+10.9%) |
| 110° | 24.82 | 28.30 | 27.20 | 35.05 | 43.70 | 40.70 |
| | | (+14.0%) | (+9.6%) | | (+24.7%) | (+16.1%) |
| 120° | 18.24 | 19.63 | 19.45 | 23.17 | 25.66 | 25.35 |
| | | (+7.6%) | (+6.6%) | | (+10.8%) | (+9.4%) |

In the idealized situation (“transmitting”), the usable luminous flux values are the highest for all tested apex angles. Lower values for the usable luminous flux are observed for the glare control structure compared to the idealized situation, which represent the usable luminous flux using the state-of-the-art glare control structure. The usable luminous flux is increased by using a transparent multi-layer system comprising the glare control structure as layer L₁ and MgF₂ as layer L₂ compared to the uncoated glare control structure. The highest usable luminous flux using a transparent multi-layer system according to the present invention is observed for the apex angle 110° with 27.20 (CIE 117) or 40.70 (CIE190).

Using a transparent multi-layer system according to the present invention by applying MgF₂ on top of the glare control structure to form layer L₂, a gain of usable luminous flux of about 9.6% (CIE 117) or 16.1% (CIE 190) can be achieved for an apex angle of 110° compared to the use of an uncoated glare control structure. Thus, the additional coating of a glare control structure with a MgF₂ layer improves the state-of-the-art glare control structure. Further, the gain is close to the idealized case, wherein a gain of usable luminous flux of about 14% is achieved.

Thus, the simulation demonstrates that glaring beams are still observed when a glare control structure is used on top of a luminaire. The glaring beams can occur inter alia because a fraction of light rays is partially reflected and transmitted at each interface of the two materials of different refractive index. Therefore, glaring beams are still observed when uncoated glare control structures are used since the light rays that were previously partially reflected at the cone-air-interface can exit the cone structure with glaring propagation angles. As a result, occupants in the illuminated space are still disturbed by glaring beams. However, a coating on top of the glare control structure using for example MgF₂ reduces glaring beams as demonstrated by the data shown in Tables 1 and 2. Thus, these glaring beams are suppressed by the inventive transparent multi-layer system of the present invention. The data of the simulation was verified by preparing a transparent multi-layer system according to the present invention.

### Preparation of the Inventive Transparent Multi-Layer System

To verify the simulation outlined hereinbefore, an uncoated glare control structure (“GCS”) was compared to the inventive transparent multi-layer system comprising a coated glare control structure, wherein a MgF₂ layer having a dry layer thickness of 95 mm was coated on top of microstructure comprising surface of the glare control structure (“MgF₂”).

A glare-control structure having an apex angle of 110° was prepared according to CH 711562 A1 (“GCS”).

The glare control structure represents layer L₁ of the inventive transparent multi-layer system according to the present invention. To prepare the inventive transparent multi-layer system, the glare control structure was coated with MgF₂ by physical vapor deposition to form layer L₂. The glare control structure (GCS) was prepared by roll-to-roll UV nanoimprint lithography on a polyethylene terephthalate substrate having a layer thickness of 250 μm.

The usable luminous flux was calculated as follows: measurement of luminous intensity distribution of the light emitting surface with nearly Lambertian emittance characteristics with a glare control film on top (with an air gap in between). Measurement was done using a goniophotometer. From the luminous intensity distribution, the UGR was calculated and the use φ was calculated from this as described herein above. This was done for each sample in Table 3.

TABLE 3

| | GCS | | | MgF₂ | | | Average |
|---|---|---|---|---|---|---|---|
| | #1 | #2 | #3 | #1 | #2 | #3 | Gain useφ |
| useφ (klm/m²) | 23.71 | 23.71 | 23.71 | 25.12 | 25.12 | 24.41 | 4.9% |

The results indicated in Table 3 highlight that the transparent multi-layer system according to the present invention increases the usable luminous flux. The gain of the usable luminous flux can be achieved due to the suppression of glaring beams as outlined hereinbefore in Table 1. Thus, the simulation of the three conditions “GCS”, “transmitting” and “MgF₂” outlined in Tables 1 and 2 are confirmed by the experimental data shown in Table 3. Consequently, it is to be assumed that any simulations of multi-layer systems will also correspond to the experimentally obtained data and thus may give a good prediction of the glare reduction by applying a layer L₂.

Therefore, the transparent multi-layer system according to the present invention improves the state-of-the-art glare control structures by suppressing glaring beams, which are observed inter alia because light rays are partially reflected and transmitted at the glare control structures. Consequently, the transparent multi-layer system can be applied on light emitting devices such as luminaires to provide a higher glare-free luminous flux. Further, occupants in the illuminated space are not disturbed by glaring beams.

1. A transparent multi-layer system, comprising:
a) a layer L₁ being composed of a transparent material having at least one surface possessing microstructures which provide layer L₁ with glare control properties, and
b) a layer L₂ being composed of one or more transparent materials providing layer L₂ with anti-reflective properties,
wherein layer L₂ is on top of the surface of layer L₁ possessing the microstructures.

2. The transparent multi-layer system according to claim 1, wherein the microstructures of layer L₁ possess a height in the range from 5 μm to 5000 μm.

3. The transparent multi-layer system to claim 1, wherein the material forming layer L₁ has a refractive index n₁, wherein the refractive index n₁ is in the range from 1.35 to 2.00 determined at a wavelength of light of 589 nm.

4. The transparent multi-layer system according to claim 1, wherein the layer L₁ is formed from a glass, a polymeric material, blends of polymeric materials, or blends of polymeric and inorganic material.

5. The transparent multi-layer system according to claim 4, wherein the polymeric material of layer L₁ is a plastic foil, a plastic sheet, or a cured coating composition C₁.

6. The transparent multi-layer system according to claim 1, wherein the microstructures of layer L₁ are designed as cones, pyramids with a triangular or square base, inverse pyramids with a triangular or square base, prisms, Fresnel lens-like structures, micro-lens-like structures having a hexagonal or square grid layout, a combination of two linear structures of prisms, or a mixture thereof, and/or wherein the microstructures have a hexagonal, a square, or other grid layout.

7. The transparent multi-layer system according to claim 1, wherein the layer L₂ is selected from the group consisting of anti-reflective coating structures and/or the group consisting of anti-reflective coating surfaces.

8. The transparent multi-layer system according to claim 7, wherein the anti-reflective coating structures are selected from the group consisting of single-layer antireflective coatings, double-layer antireflective coatings, multi-layer antireflective coatings and gradient refractive index coatings, and the anti-reflective coating surfaces are selected from the group consisting of porous layers, biomimetic photonic nanostructures, and textured surfaces.

9. The transparent multi-layer system according to claim 1, wherein the materials forming layer L₂ are selected from the group consisting of silicon-based coating materials; metal-based coating materials; polymer-based coating materials; and composite coating materials.

10. The transparent multi-layer system according to claim 1, wherein the layer L₂ is a single-layer anti-reflective coating layer consisting of magnesium difluoride and possessing a dry layer thickness d_{L} in the range of 85 to 175 nm.

11. The transparent multi-layer system according to claim 1, wherein the layer L₁ is
on top of a support layer Lₛ; or
on top of an adhesive layer Lₐ; or
on top of a support layer Lₛ, wherein the support layer Lₛ is on top of an adhesive layer Lₐ.

12. A method of producing a transparent multi-layer system as defined in claim 1 comprising the steps of
i. forming a layer L₁, comprising microstructures on at least one surface, followed by
ii. forming an anti-reflective layer L₂ by
a. depositing one or more coating materials on top of the surface of layer L₁ possessing the microstructures, thus forming an anti-reflective coating layer L₂, or
b. partially removing material from the surface of layer L₁ possessing the microstructures thereby maintaining the shape of the microstructures and thus forming an anti-reflective layer L₂ being from the same material as layer L₁.

13. A method of producing a transparent multi-layer system according to claim 10, wherein the microstructures of layer L₁ in step i. are formed by one or more of laser ablation, hot stamping, ultraviolet casting, injection molding, compression molding, roll-to-roll process, embossing process, plasma etching process, sol-gel-process and/or 3D printing.

14. The method of producing a transparent multi-layer system according to claim 12, wherein the layer L₂ in step ii. is formed by one or more of techniques selected from the group consisting of sol-gel methods, thermal evaporation, sputtering, glancing angle deposition (GLAD), chemical vapor deposition (CVD), wet-etching and dry-etching, lithography, focused ion beam techniques, nanoimprint techniques, micro replication, photo aligning and photo patterning.

15. A transparent multi-layer system, wherein the transparent multi-layer system is obtained according to the method as defined in claim 12.

16. A method of using a transparent multi-layer system according to claim 1, the method comprising using the transparent multi-layer system as a glare-reducing component of a light emitting device.

17. A luminaire, comprising a light source and the transparent multi-layer system as defined in claim 1.

18. The method of producing a transparent multi-layer system according to claim 12, comprising the step of
i. forming a layer L₁, comprising microstructures on one surface.

19. The method of producing a transparent multi-layer system according to claim 13, wherein the layer L₂ in step ii. is formed by one or more of techniques selected from the group consisting of sol-gel methods, thermal evaporation, sputtering, glancing angle deposition (GLAD), chemical vapor deposition (CVD), wet-etching and dry-etching, lithography, focused ion beam techniques, nanoimprint techniques, micro replication, photo aligning and photo patterning.

20. A transparent multi-layer system, wherein the transparent multi-layer system is obtained according to the method as defined in claim 13.
